(19) United States
(12) Patent Application Publication
(10) Pub. No.: US 2011/0121503 A1
(43) Pub. Date: May 26, 2011

(54) CVD APPARATUS

(75) Inventors: BRIAN H. BURROWS, San Jose, CA (US); Ronald Stevens, San Ramon, CA (US); Jacob Grayson, Midland, MI (US); Joshua J. Podesta, San Jose, CA (US); Sandeep Nijhawan, Los Altos, CA (US); Lori D. Washington, Union City, CA (US); Alexander Tam, Union City, CA (US); Sumedh Acharya, Pune (IN)

(73) Assignee: APPLIED MATERIALS, INC., Santa Clara, CA (US)

(21) Appl. No.: 12/850,738

(22) Filed: Aug. 5, 2010

Related U.S. Application Data
(60) Provisional application No. 61/231,553, filed on Aug. 5, 2009.

(51) Int. Cl. B23Q 3/00

(52) U.S. Cl. 269/289 R

(57) ABSTRACT

Embodiments of the present invention generally relate to methods and apparatus for chemical vapor deposition (CVD) on a substrate, and, in particular, to a process chamber and components for use in metal organic chemical vapor deposition. The apparatus comprises a chamber body defining a process volume. A showerhead in a first plane defines a top portion of the process volume. A carrier plate extends across the process volume in a second plane forming an upper process volume between the showerhead and the susceptor plate. A transparent material in a third plane defines a bottom portion of the process volume forming a lower process volume between the carrier plate and the transparent material. A plurality of lamps forms one or more zones located below the transparent material. The apparatus provides uniform precursor flow and mixing while maintaining a uniform temperature over larger substrates thus yielding a corresponding increase in throughput.

### CROSS-REFERENCE TO RELATED APPLICATIONS

This application claims benefit of U.S. Provisional Patent Application Ser. No. 61/231,553 (APPM/11977L), filed Aug. 5, 2009, which is herein incorporated by reference.

### BACKGROUND OF THE INVENTION

1. Field of the Invention

Embodiments of the present invention generally relate to methods and apparatus for chemical vapor deposition (CVD) on a substrate, and, in particular, to a process chamber for use in chemical vapor deposition.

2. Description of the Related Art

Group III-V films are finding greater importance in the development and fabrication of a variety of semiconductor devices, such as short wavelength light emitting diodes (LEDs), laser diodes (LDs), and electronic devices including high power, high frequency, high temperature transistors and integrated circuits. For example, short wavelength (e.g., blue/green to ultraviolet) LEDs are fabricated using the Group III-nitride semiconducting material gallium nitride (GaN). It has been observed that short wavelength LEDs fabricated using GaN can provide significantly greater efficiencies and longer operating lifetimes than short wavelength LEDs fabricated using non-nitride semiconducting materials, comprising Group II-VI elements.

One method that has been used for depositing Group III-nitrides, such as GaN, is metal organic chemical vapor deposition (MOCVD). This chemical vapor deposition method is generally performed in a reactor having a temperature controlled environment to assure the stability of a first precursor gas which contains at least one element from Group III, such as gallium (Ga). A second precursor gas, such as ammonia (NH₃), provides the nitrogen needed to form a Group III-nitride. The two precursor gases are injected into a processing zone within the reactor where they mix and move towards a heated substrate in the processing zone. A carrier gas may be used to assist in the transport of the precursor gases towards the substrate. The precursors react at the surface of the heated substrate to form a Group III-nitride layer, such as GaN, on the substrate surface. The quality of the film depends in part upon deposition uniformity which, in turn, depends upon uniform flow and mixing of the precursors across the substrate.

As the demand for LEDs, LDs, transistors, and integrated circuits increases, the efficiency of depositing high quality Group-III nitride films takes on greater importance. Therefore, there is a need for an improved deposition apparatus and process that can provide uniform precursor mixing and consistent film quality over larger substrates and larger deposition areas.

### SUMMARY OF THE INVENTION

The present invention generally relates to methods and apparatus for chemical vapor deposition (CVD) on a substrate, and, in particular, to a process chamber and components for use in chemical vapor deposition.

In one embodiment a reflector is disclosed. The reflector includes a reflector body having a flange portion, a surface coated with gold and an opening through the reflector body. The opening through the reflector body has a diameter of between about 6 inches and about 7 inches at a first end and about 9 inches and about 10 inches at the other end.

In another embodiment, a reflector is disclosed. The reflector includes a reflector body having a flange portion and an opening through the reflector body. The opening through the reflector body has a diameter of between about 10 inches and about 11 inches at a first end and about 12 inches and about 13 inches at the other end.

In another embodiment, a substrate carrier is disclosed. The substrate carrier includes a substrate carrier body having twenty-eight slots formed therein. The slots are disposed such that the center of the slots are centered along three separate radial distances from the center of the substrate carrier body. Three slots are disposed along a first diameter, nine slots are disposed along a second diameter that is greater than the first diameter and sixteen slots are disposed along a third diameter that is greater than the second diameter.

In another embodiment, a chamber liner is disclosed. The chamber liner includes a circular body having an opening therethrough. The opening has a diameter of between about 14 inches and about 15 inches at one end of the body and a non-circular opening at the other end of the body bounded by a jagged edge.

In another embodiment, a cover ring is disclosed. The cover ring includes a circular cover ring body having an opening therethrough that has a diameter of between about 13 inches and about 14 inches. The cover ring body has an inner flange with a height of between about 0.05 inches and about 0.07 inches, a middle flange having a height of between about 0.2 inches and about 0.3 inches and an outer flange having a height of between about 0.1 inches and about 0.2 inches.

In another embodiment, an edge ring is disclosed. The edge ring includes an edge ring body having an opening therethrough that has a diameter of between about 380 mm and about 390 mm and a first lip having a diameter of between about 180 mm and about 185 mm.

In another embodiment, a top ring is disclosed. The top ring includes a top ring body having an opening with a diameter of between about 400 mm and about 425 mm and an edge flange with a height of between about 5 mm and about 6 mm.

In another embodiment, an exhaust ring is disclosed. The exhaust ring includes an exhaust ring body having a plurality of teeth extending therefrom that are separated by a gully, the gully having a width of between about 0.3 inches and about 0.4 inches and a depth of between about 0.05 inches and about 0.2 inches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a cross-sectional view of a deposition chamber according to one embodiment of the invention.

FIG. 2 is a partial cross-sectional view of the deposition chamber of FIG. 1.

FIG. 3 is a perspective view of a carrier plate according to one embodiment of the invention.

FIG. 4A is a perspective view of an upper surface of a susceptor plate according to one embodiment of the invention.

FIG. 4B is a perspective view of a lower surface of the susceptor plate according to one embodiment of the invention.

FIG. 5A is a perspective view of a susceptor support shaft according to one embodiment of the invention.

FIG. 5B is a perspective view of a susceptor support shaft according to another embodiment of the invention.

FIG. 5C is a perspective view of a susceptor support shaft according to another embodiment of the invention.

FIG. 6 is a perspective view of a carrier lift shaft according to one embodiment of the invention.

FIG. 7 is a schematic view of an exhaust process kit according to one embodiment of the invention.

FIG. 8A is a perspective view of an upper liner according to one embodiment of the invention.

FIG. 8B is a perspective view of a lower liner according to one embodiment of the invention.

FIGS. 9A-9D are schematic representations of a reflector 900 according to one embodiment.

FIGS. 10A-10C are schematic representations of a reflector 1000 according to another embodiment.

FIGS. 11A-11F as schematic representations of a carrier 1100 according to one embodiment.

FIGS. 12A-12E are schematic representations of a cover ring 1200 according to one embodiment.

FIGS. 13A-13F are schematic representations of a cover ring 1300 according to another embodiment.

FIGS. 14A-14D are schematic representations of a top ring 1400 according to one embodiment.

FIGS. 15A-15H are schematic views of an exhaust ring 1500 according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

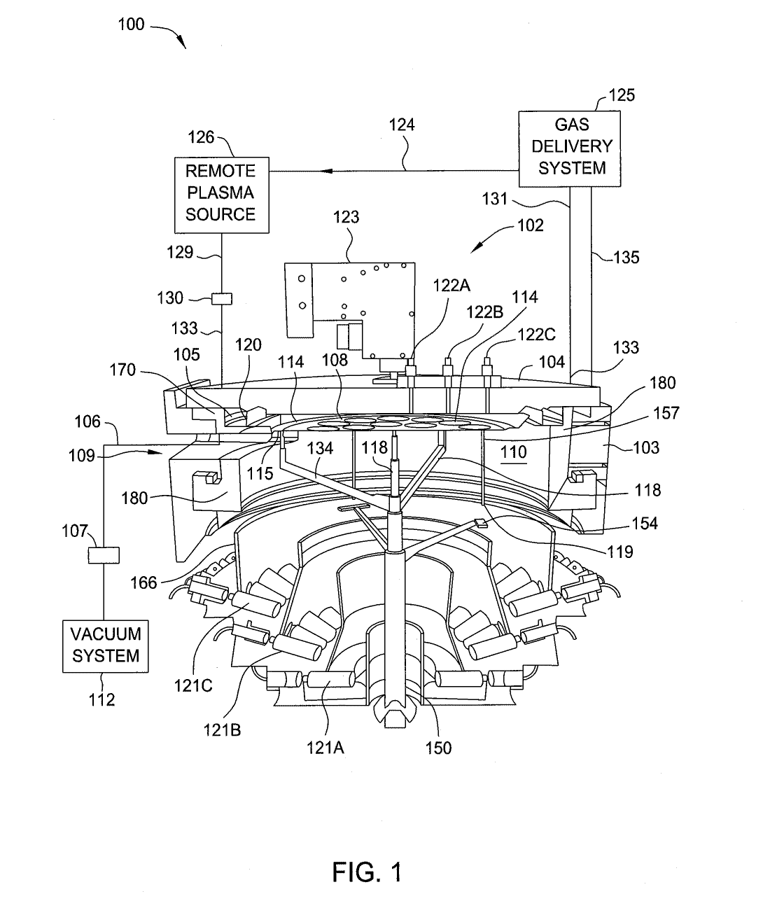

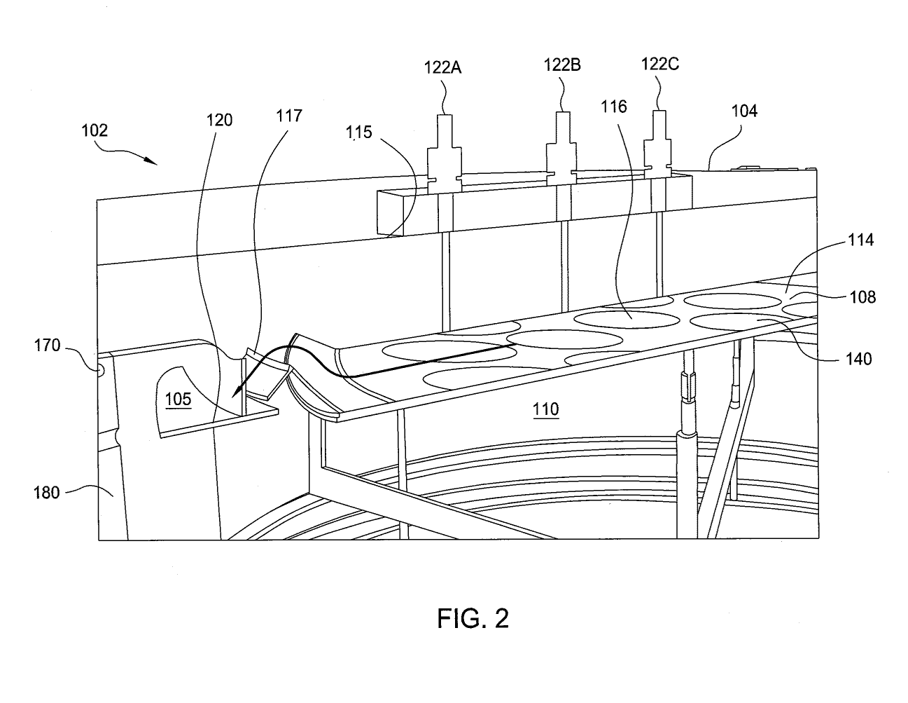

Embodiments of the present invention generally provide a method and apparatus that may be utilized for deposition of Group III-nitride films using MOCVD. Although discussed with reference to MOCVD, embodiments of the present invention are not limited to MOCVD. FIG. 1 is a cross-sectional view of a deposition apparatus that may be used to practice the invention according to one embodiment of the invention. FIG. 2 is a partial cross-sectional view of the deposition chamber of FIG. 1. A MOCVD system that may be adapted to practice the inventions disclosed herein may be purchased from Applied Materials, Inc., Santa Clara, Calif. It is to be understood that the inventions disclosed herein may be practiced in chambers purchased from other manufacturers as well.

With reference to FIG. 1 and FIG. 2, the apparatus 100 comprises a chamber 102, a gas delivery system 125, a remote plasma source 126, and a vacuum system 112. The chamber 102 includes a chamber body 103 that encloses a processing volume 108. The chamber body 103 may comprise materials such as stainless steel or aluminum. A showerhead assembly 104 or gas distribution plate is disposed at one end of the processing volume 108, and a carrier plate 114 is disposed at the other end of the processing volume 108. A transparent material 119, configured to allow light to pass through for radiant heating of substrates 140, is disposed at one end of a lower volume 110 and the carrier plate 114 is disposed at the other end of the lower volume 110. The transparent material 119 may be dome shaped. The carrier plate 114 is shown in process position, but may be moved to a lower position where, for example, the substrates 140 may be loaded or unloaded.

FIG. 3 is a perspective view of a carrier plate according to one embodiment of the invention. In one embodiment, the carrier plate 114 may include one or more recesses 116 within which one or more substrates 140 may be disposed during processing. In one embodiment, the carrier plate 114 is configured to carry six or more substrates 140. In another embodiment, the carrier plate 114 is configured to carry eight substrates 140. In another embodiment, the carrier plate 114 is configured to carry eighteen substrates. In yet another embodiment, the carrier plate 114 is configured to carry twenty-two substrates. It is to be understood that more or less substrates 140 may be carried on the carrier plate 114. Typical substrates 140 may include sapphire, silicon carbide (SiC), silicon, or gallium nitride (GaN). It is to be understood that other types of substrates 140, such as glass substrates 140, may be processed. Substrate 140 size may range from 50 mm-100 mm in diameter or larger. The carrier plate 114 size may range from 200 mm-750 mm. The carrier plate 114 may be formed from a variety of materials, including SiC or SiC-coated graphite. It is to be understood that substrates 140 of other sizes may be processed within the chamber 102 and according to the processes described herein.

The carrier plate 114 may rotate about an axis during processing. In one embodiment, the carrier plate 114 may be rotated at about 2 RPM to about 100 RPM. In another embodiment, the carrier plate 114 may be rotated at about 30 RPM. Rotating the carrier plate 114 aids in providing uniform heating of the substrates 140 and uniform exposure of the processing gases to each substrate 140. In one embodiment, the carrier plate 114 is supported by a carrier supporting device comprising a susceptor plate 115.

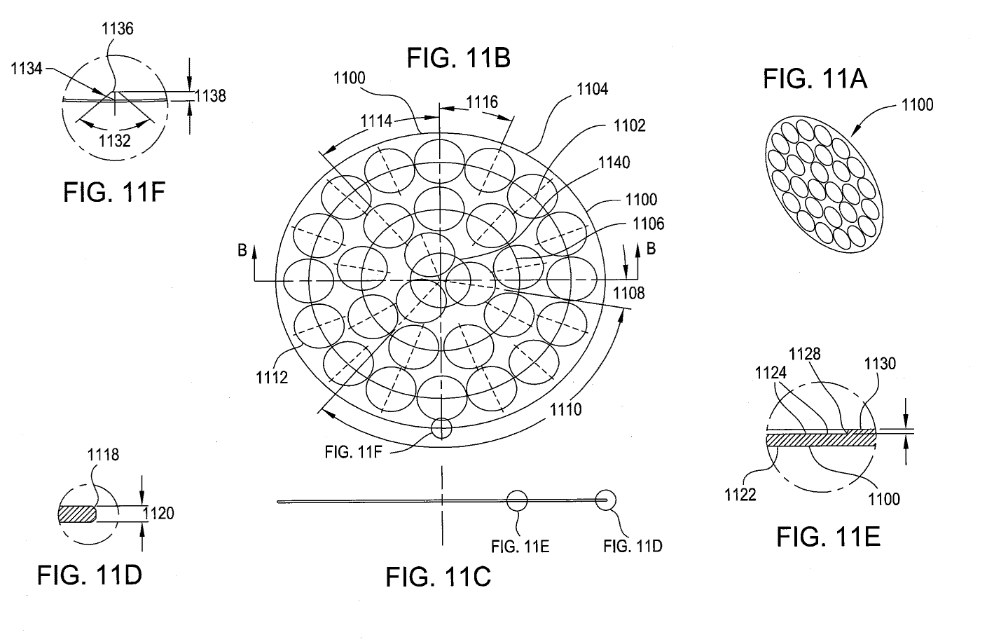

FIGS. 11A-11F as schematic representations of a carrier 1100 according to one embodiment. The carrier 1000 includes a plurality of slots 1112 for holding a substrate during processing. In one embodiment, twenty-eight slots 1112 may be present. The slots 1112 may be arranged along three separate diameters. Three slots 1112 may be disposed along a diameter of between about 2.0 inches and about 3.0 inches as shown by arrows 1140. Nine slots 1112 may be disposed along a diameter of between about 6.0 inches and about 7.0 inches as shown by arrows 1106. Sixteen slots 1112 may be disposed along a diameter of between about 10 inches and about 11 inches as shown by arrows 1102. The outside diameter of the carrier 1100 may be between about 13 inches and about 14 inches as shown by arrows 1104. The center of a slot 1112 along the innermost diameter and the center of a slot 1112 along the outermost diameter may be spaced apart from between about 8 degrees and about 11 degrees as shown by arrows 1108. The centers of two slots 1112 disposed in the innermost diameter may be between about 110 degrees and about 130 degrees as shown by arrows 1110. The center of two adjacent slots 1112 along the middle diameter may be between about 35 degrees and about 42 degrees as shown by arrows 1114. The centers of adjacent slots 1112 along the outermost diameter may be between about 22 degrees and about 25 degrees as shown by arrows 1116. The outside edge of the carrier 1100 may be rounded at an angle of between about 40 degrees and about 50 degrees as shown by arrows 1118 and have a thickness of between about 0.01 inches and about 0.075 inches as shown by arrows 1120.

The carrier 1100 has a bottom surface 1122 opposite the slots 1112 and top surface 1130. Each slot 1112 has a sidewall 1128 ending in a bottom surface 1124. The sidewall 1128 is substantially perpendicular to the top surface 1130. The bottom surface 1124 of the carrier has a concave surface, relative to a substrate that will rest thereon. In particular, the bottom surface 1124 curves immediately from the sidewall 1128 of the carrier 1100 such that no ledge is present. Additionally, because the bottom surface 1124 is concave, the area of the substrate that is in contact with the carrier 1100 is minimized. The edge of the carrier 1100 may have a slanted slot 1136 that is angled at between about 80 degrees and about 100 degrees as shown by arrows 1132 and a radius of between about 0.025 inches and about 0.5 inches as shown by arrows 1134. The slanted slot 1136 may extend between about 0.03 inches and about 0.05 inches into the carrier 1100.

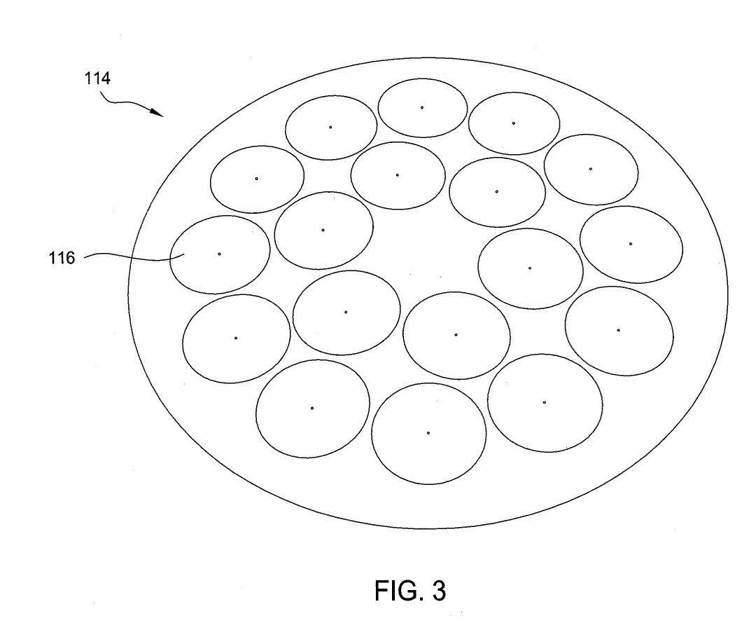

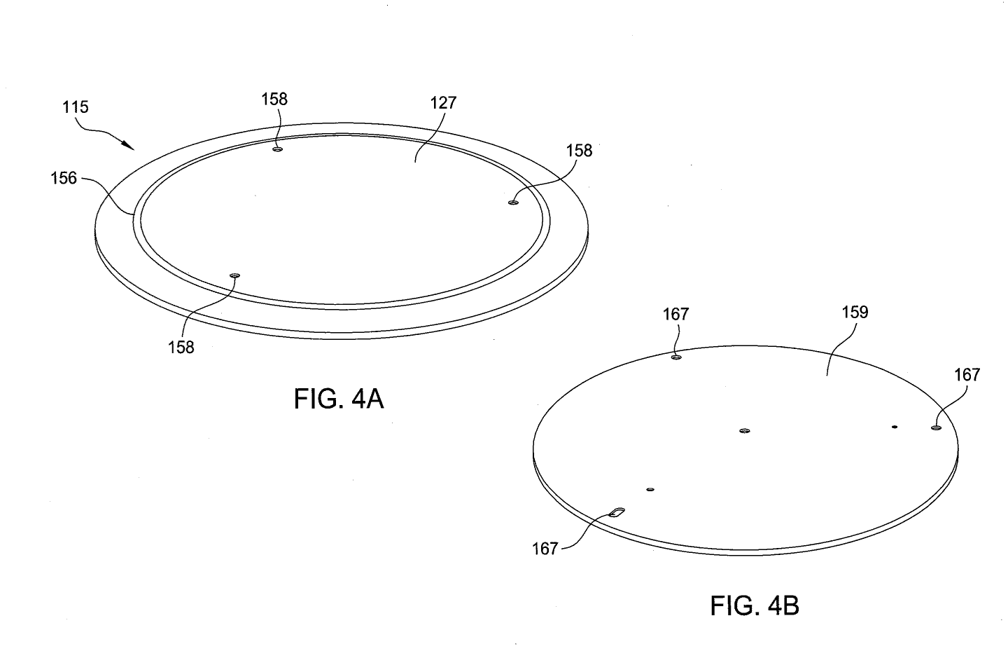

FIG. 4A is a perspective view of an upper surface of a susceptor plate according to one embodiment of the invention. FIG. 4B is a perspective view of a lower surface of the susceptor plate according to one embodiment of the invention. The susceptor plate 115 has a disk form and is made of a graphite material coated with silicon carbide. The upper surface 156 of the susceptor plate 115 is formed with a circular recess 127. The circular recess 127 acts as a support area for accommodating and supporting the carrier plate 114. The susceptor plate 115 has three throughholes 158 for accommodating lift pins. The susceptor plate 115 is horizontally supported at three points from the underside by a susceptor support shaft 118 made of quartz disposed in the lower volume 110 of the chamber. The lower surface 159 of the susceptor plate has three holes 167 for accommodating the lift arms of the susceptor support shaft 118. Although the susceptor plate 115 is described as having three holes 167, any number of holes corresponding to the number of lift arms of the susceptor support shaft 118 may be used.

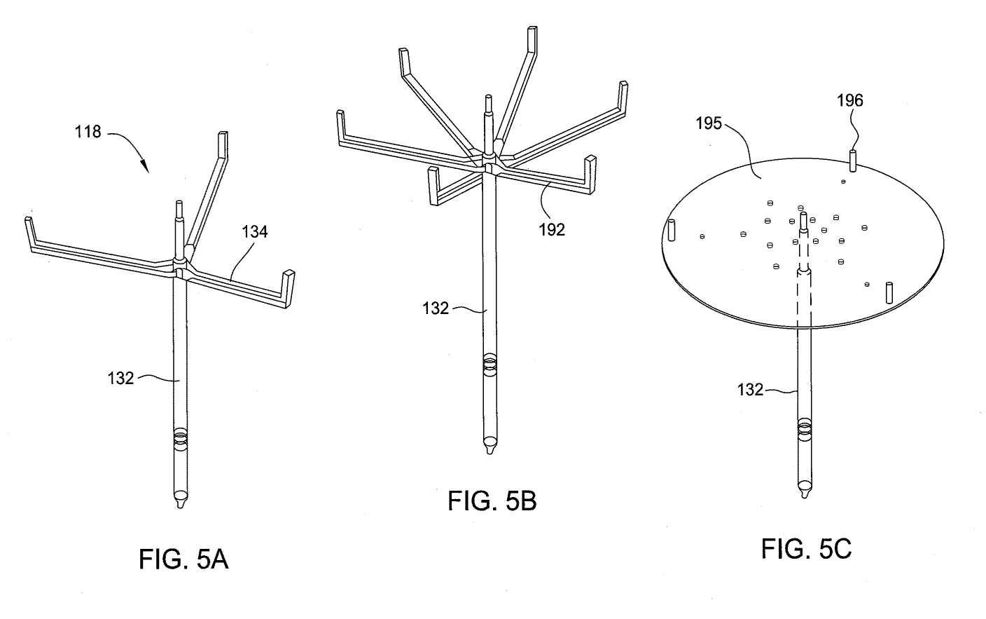

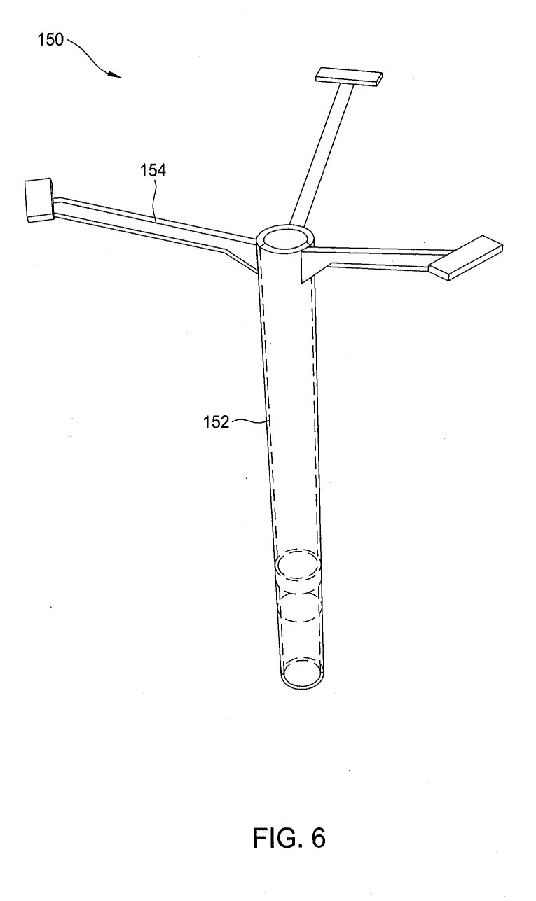

The lift mechanism 150 will be discussed with respect to FIGS. 5A-5C and FIG. 6. FIG. 5A is a perspective view of the susceptor support shaft and FIG. 6 is a perspective view of a carrier plate lift mechanism. The susceptor support shaft 118 comprises a central shaft 132 with three lift arms 134 extending radially from the central shaft 132. Although the susceptor support shaft 118 is shown with three lift arms 134, any number of lift arms greater than three may also be used, for example, the susceptor support shaft 118 may comprise six lift arms 192 as depicted in FIG. 5B. In one embodiment depicted in FIG. 5C the lift arms are replace by a disk 195 with support posts 196 extending from the surface of the disk 195 to support the susceptor plate 115.

The carrier plate lift mechanism 150 comprises a vertically movable lift tube 152 arranged so as to surround the central shaft 132 of the susceptor support shaft 118, a driving unit (not shown) for moving the lift tube 152 up and down, three lift arms 154 radially extending from the lift tube 152, and lift pins 157 suspended from the bottom surface of the susceptor plate 115 by way of respective throughholes 158 formed so as to penetrate therethrough. When the driving unit is controlled so as to raise the lift tube 152 and lift arms 154 in such a configuration, the lift pins 157 are pushed up by the distal ends of the lift arms 154 whereby the carrier plate 114 rises.

As shown in FIG. 1, radiant heating may be provided by a plurality of inner lamps 121A, a plurality of central lamps 121B, and a plurality of outer lamps 121C disposed below the lower dome 119. Reflectors 166 may be used to help control chamber 102 exposure to the radiant energy provided by the inner, central, and outer lamps 121A, 121B, 121C. Additional zones of lamps may also be used for finer temperature control of the substrates 140. In one embodiment, the reflectors 166 are coated with gold. In another embodiment, the reflectors 166 are coated with aluminum, rhodium, nickel, combinations thereof, or other highly reflective materials. In one embodiment, there are 72 lamps total comprising 24 lamps per zone at 2 kilowatts per lamp. In one embodiment, the lamps are air-cooled and the bases of the lamps are water cooled.

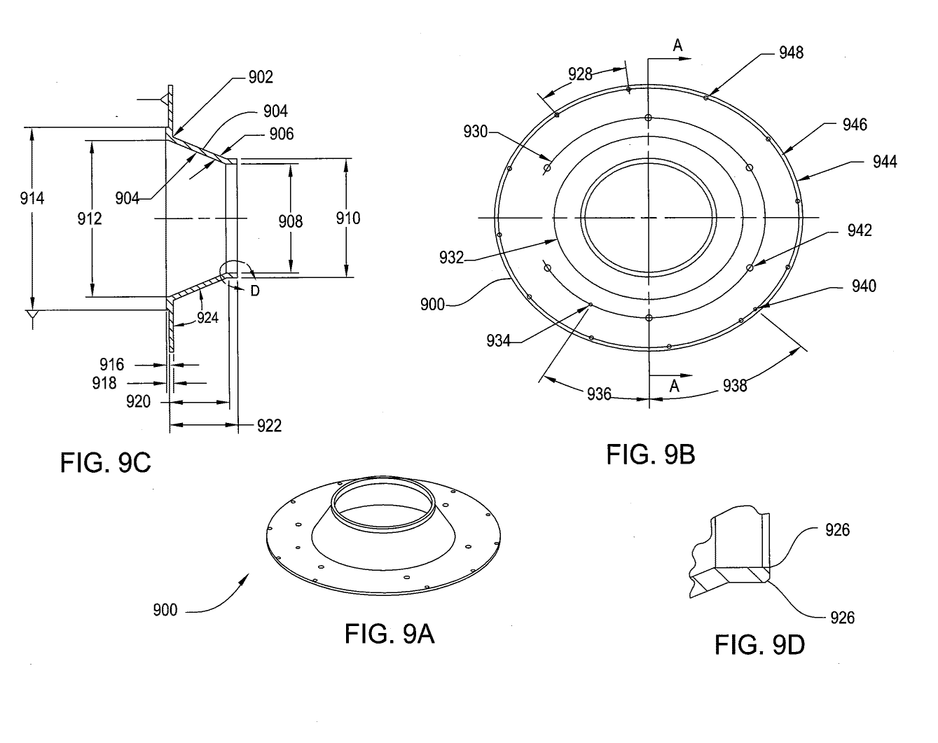

FIGS. 9A-9D are schematic representations of a reflector 900 according to one embodiment. The reflector is shown from a top view in FIG. 9B and cross-sectional in FIG. 9C. The reflector comprises a bottom ledge area 902 that extends out to the full diameter of the reflector 900 as shown by arrows 944 which can be between about 15 inches to about 17 inches in diameter. The reflector 900 slopes up from the ledge area 902 at an angle of between about 100 degrees and about 120 degrees as shown by arrows 924. The sloped inner and outer surfaces of the reflector 900 may be coated with a highly reflective material 904 such as gold to ensure a maximum reflectance. The reflector 900, however, may comprise copper. The sloping portion of the reflector 900 may have a width of between about 0.20 inches to about 0.30 inches as shown by arrows 906. The sloped sides of the reflector 900 may end at a straight portion that is substantially parallel to the centerline through the opening of the reflector 900 in which the upper corners 926 of the reflector may be rounded.

Because of the sloping surfaces, the reflector 900 has an opening at the top that is less than the opening at the bottom. The opening at the top may have a diameter of between about 6 inches and about 6.5 inches as shown by arrows 908. The outside diameter of the opening at the top may be between about 6.5 inches and about 7.0 inches as shown by arrows 910. On the other hand, the opening at the bottom of the reflector 900 may have a diameter of between about 9.0 inches and about 9.25 inches as shown by arrows 912. The flange area 902 of the reflector may begin at a distance of between about 0.1 inches to about 0.2 inches above the bottom of the reflector 900 as shown by arrows 916. The very bottom surface of the reflector 900 may have a diameter of between about 10 inches and about 10.5 inches as shown by arrows 914. The flange area 902 may have a height of between about 0.3 inches and about 0.4 inches as shown by arrows 918. The area from the bottom of the flange area 902 to the end of the sloped slides may have a height of between about 2.80 inches and about 3.0 inches as shown by arrows 920. The reflector 900 may have a total height from the bottom of the flange area 902 to the top of the reflector 900 of between about 3.25 inches and about 3.5 inches as shown by arrows 922.

A plurality of holes 942 may be bored through the reflector 900. The holes 942 may be centered with the opening of the reflector 900 along a diameter of between about 11.25 inches and about 11.60 inches as shown by arrows 930. An additional hole 934 may be present at the same diameter as holes 942, but hole 934 may have a smaller diameter. The additional hole 934 may be spaced a radial angle of between about 25 degrees and about 32 degrees from another hole 942 as shown by arrows 936. The sloped walls of the reflector 900 begin to slope upwards from a diameter of between about 9.30 inches to about 9.50 inches as shown by arrows 932. Additional holes 948 may be spaced at a greater distance from the center of the reflector 900 at a diameter of between about 14.5 inches and about 15.0 inches as shown by arrows 946. Additional holes 940 may be present, but the diameter of the holes 940 may be smaller than the diameter of the holes 948. The additional hole 940 may be spaced between about 40 degrees and about 50 degrees from on of the holes 942 as shown by arrows 938. The holes 948 may be spaced between about 25 degrees and about 32 degrees from holes 942 as shown by arrows 928.

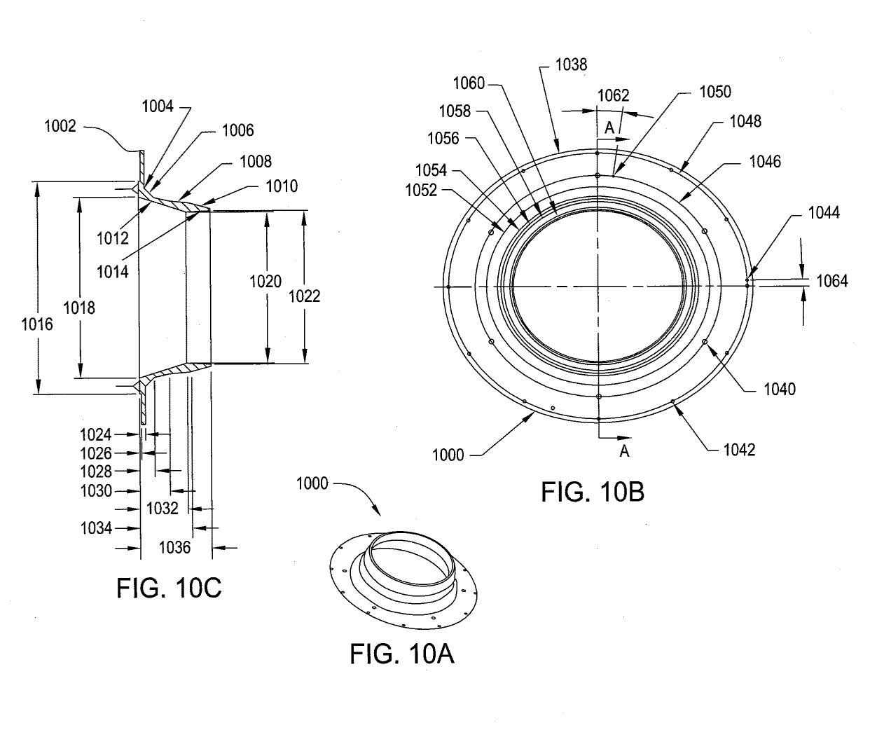

FIGS. 10A-10C are schematic representations of a reflector 1000 according to another embodiment. The reflector 1000 has a flange area 1002 that has a height of between about 0.1 inch and about 0.2 inches as shown by arrows 1026 and begins at a height of between about 0.3 inches and about 0.35 inches above the bottom of the reflector 1000 as shown by arrows 1024. The outside surface of the reflector 1000 bends at a corner 1004 before hitting a straight section 1006 and then curves up again along a side surface 1008 before curving inwards along surface 1010. The inside of the reflector 1000 slopes upward along surface 1012 before turning slightly away parallel with the centerline through the opening along sidewall 1014. The bottom of the reflector 1000, not including the flange area 1002, has a total diameter of between about 14 inches and about 15 inches as shown by arrows 1016. The bottom opening of the reflector 1000 has a diameter of between about 12 inches and about 13 inches as shown by arrows 1018. The intersection of sidewall 1012 and sidewall 1014 has a diameter of between about 10 inches and about 11 inches as shown by arrows 1020 while the top opening of the reflector 1000 has a diameter of between about 10.5 inches and about 11.5 inches as shown by arrows 1022.

The reflector 1000 has a height of between about 1.0 inches and about 1.25 inches form the bottom of the reflector 1000 to the beginning of the sidewall 1008 as shown by arrows 1028. The reflector 1000 has a height of between about 1.60 inches to about 1.80 inches from the bottom of the reflector 1000 to the middle of the sidewall 1008 as shown by arrows 1030. The reflector 1000 has a height of between about 2.95 inches and about 3.10 inches from the bottom of the reflector 1000 to the intersection of sidewall 1012 and sidewall 1014 as shown by arrows 1032. The reflector 1000 has a height of between about 3.10 inches and about 3.30 inches from the bottom of the reflector 1000 and the intersection of sidewalls 1008 and 1010 as shown by arrows 1034. The total height of the reflector 1000 is between about 4.35 inches and about 4.65 inches as shown by arrows 1036. The total diameter of the reflector 1000, including the flange area 1002 is between about 19 inches and about 20 inches as shown by arrows 1038.

A plurality of holes 1040 may be bored through the reflector 1000. The holes 1040 may be disposed along a diameter that is centered with the opening of the reflector 1000 at a diameter of between about 15 inches and about 15.75 inches as shown by arrows 1046. An additional opening 1050 may be present at the same diameter as the holes 1040, but spaced between about 5 degrees to about 10 degrees from one of he holes 1040 as shown by arrows 1062. Additional holes 1042 may be bored through the reflector 1000 at a greater distance from the center of the opening. The additional holes 1042 may be disposed along a diameter that is centered with the opening of the reflector 1000 along a diameter that is between about 18.50 inches and about 19.0 inches as shown by arrows 1048. An additional hole 1044 may be present along the same diameter as holes 1042, but spaced between about 2.0 degrees to about 3.0 degrees from the nearest hole 1042.

The corner 1004 may be disposed at a diameter of between about 13.5 inches to about 14.0 inches as shown by arrows 1052. The sidewall 1008 and the sidewall 1006 may meet at a diameter of between about 12.5 inches to about 13.0 inches as shown by arrows 1054. The sidewall 1008 and sidewall 1010 may meet at a diameter of between about 12.0 inches and about 12.5 inches as shown by arrows 1056. The reflector 1000 may have additional outside diameters of between about 11.5 inches and about 12.0 inches as shown by arrows 1058 and between about 11.0 inches and about 11.5 inches as shown by arrows 1060.

The plurality of inner lamps, central lamps, and outer lamps 121A, 121B, 121C may be arranged in concentric zones or other zones (not shown), and each zone may be separately powered allowing for the tuning of deposition rates and growth rates through temperature control. In one embodiment, one or more temperature sensors, such as pyrometers 122A, 122B, 122C, may be disposed within the showerhead assembly 104 to measure substrate 140 and carrier plate 114 temperatures, and the temperature data may be sent to a controller (not shown) which can adjust power to each zone to maintain a predetermined temperature profile across the carrier plate 114. In one embodiment, an inert gas is flown around the pyrometers 122A, 122B, 122C into the processing volume 108 to prevent deposition and condensation from occurring on the pyrometers 122A, 122B, 122C. The pyrometers 122A, 122B, 122C can compensate automatically for changes in emissivity due to deposition on surfaces. Although three pyrometers 122A, 122B, 122C are shown, it should be understood that any numbers of pyrometers may be used, for example, if additional zones of lamps are added it may be desirable to add additional pyrometers to monitor each additional zone. In another embodiment, the power to separate lamp zones may be adjusted to compensate for precursor flow or precursor concentration non-uniformity. For example, if the precursor concentration is lower in a carrier plate 114 region near an outer lamp zone, the power to the outer lamp zone may be adjusted to help compensate for the precursor depletion in this region. Advantages of using lamp heating over resistive heating include a smaller temperature range across the carrier plate 114 surface which improves product yield. The ability of lamps to quickly heat up and quickly cool down increases throughput and also helps create sharp film interfaces.

Other metrology devices, such as a reflectance monitor 123, thermocouples (not shown), or other temperature devices may also be coupled with the chamber 102. The metrology devices may be used to measure various film properties, such as thickness, roughness, composition, temperature or other properties. These measurements may be used in an automated real-time feedback control loop to control process conditions such as deposition rate and the corresponding thickness. In one embodiment, the reflectance monitor 123 is coupled with the showerhead assembly 104 via a central conduit (not shown).

The inner, central, and outer lamps 121A, 121B, 121C may heat the substrates 140 to a temperature of about 400 degrees Celsius to about 1200 degrees Celsius. It is to be understood that the invention is not restricted to the use of arrays of inner, central, and outer lamps 121A, 121B, and 121C. Any suitable heating source may be utilized to ensure that the proper temperature is adequately applied to the chamber 102 and substrates 140 therein. For example, in another embodiment, the heating source may comprise resistive heating elements (not shown) which are in thermal contact with the carrier plate 114.

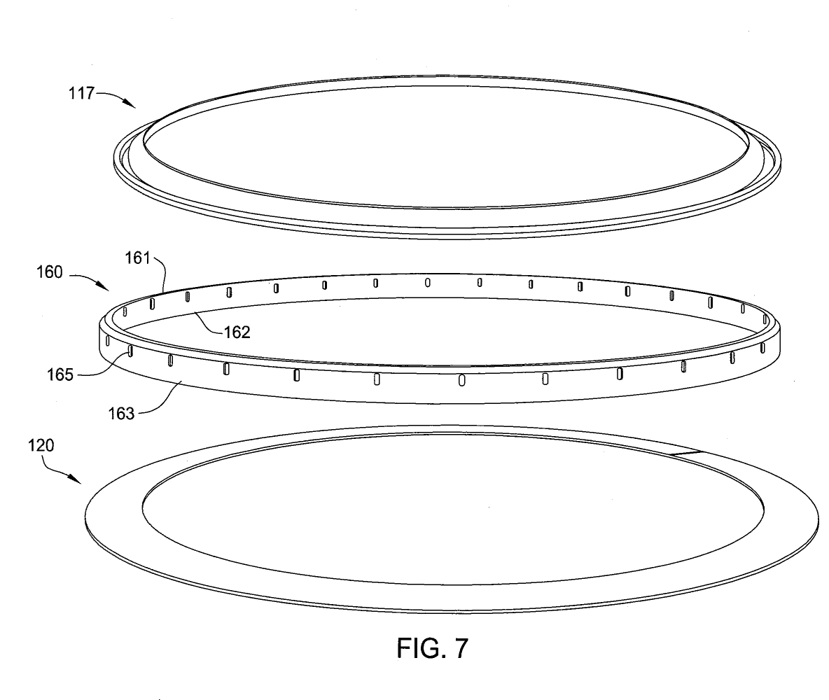

With reference to FIG. 2 and FIG. 7, FIG. 7 is a perspective view of an exhaust process kit according to one embodiment of the invention. In one embodiment, the process kit may comprise a light shield 117, an exhaust ring 120, and an exhaust cylinder 160. As shown in FIG. 2, the light shield 117 may be disposed around the periphery of the carrier plate 114. The light shield 117 absorbs energy that strays outside of the susceptor diameter from the inner lamps 121A, the central lamps 121B, and the outer lamps 121C and helps redirect the energy toward the interior of the chamber 102. The light shield 117 also blocks direct lamp radiant energy from interfering with metrology tools. In one embodiment, the light shield 117 generally comprises an annular ring with an inner edge and an outer edge. In one embodiment, the outer edge of the annular ring is angled upward. The light shield 117 generally comprises silicon carbide. The light shield 117 may also comprise alternative materials that absorb electromagnetic energy, such as ceramics. The light shield 117 may be coupled with the exhaust cylinder 160, the exhaust ring 120 or other parts of the chamber body 103. The light shield 117 generally does not contact the susceptor plate 115 or carrier plate 114.

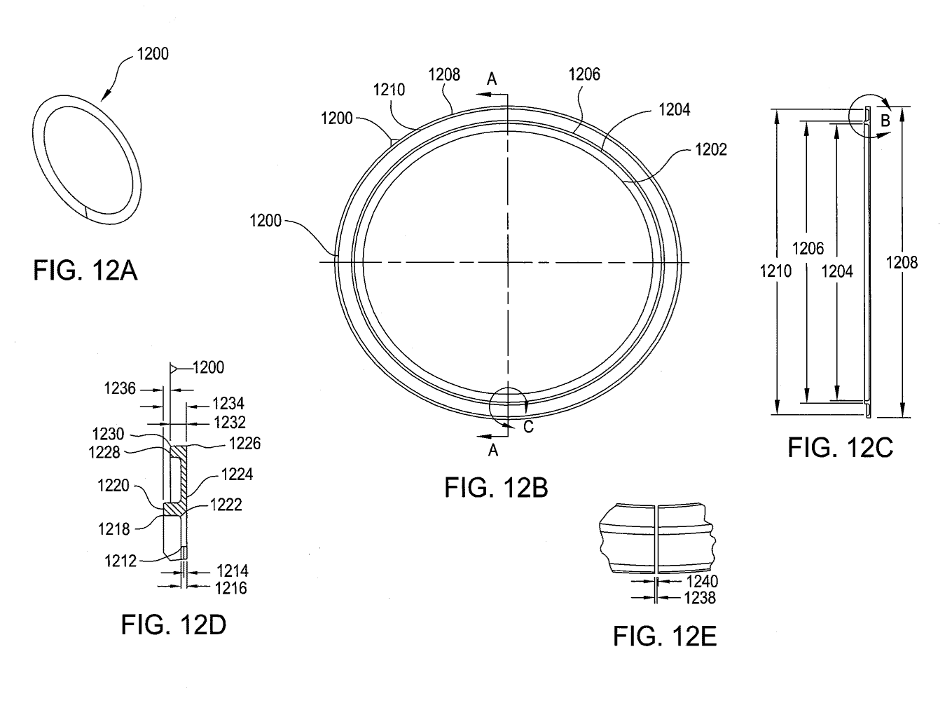

FIGS. 12A-12E are schematic representations of a cover ring 1200 according to one embodiment. In one embodiment, the cover ring 1200 may comprise carbon graphite. The cover ring 1200 has an outside diameter of between about 15 inches and about 16 inches as shown by arrows 1208. The cover ring 1200 has a top surface 1224. The edge of the cover ring 1200 has a curved corner 1212 on the flange. The height of the flange from the top of the cover ring to the corner 1212 is between about 0.02 inches to about 0.04 inches as shown by arrows 1214 while the entire flange portion has a height of between about 0.05 inches to about 0.07 inches as shown by arrows 1216. The flange area extends from a corner 1222 of the cover ring 1200. There are numerous corners 1222, 1218, 1230 and 1226 of the cover ring 1200. Corners 1222 and 1218 are disposed along a diameter of between about 15 inches and about 16 inches as shown by arrows 1210. The middle flange 1220 is disposed at a diameter of between about 14 inches and about 15 inches as shown by arrows 1206. An outer flange 1228 may also be present. The outer flange 1228 may have a height of between about 0.1 inches to about 0.2 inches as shown by arrows 1232. The middle flange 1220 may extend beyond the outer flange between about 0.07 inches to about 0.08 inches as shown by arrows 1236 and a total distance of between 0.2 inches to about 0.3 inches as shown by arrows 1234.

The cover ring 1200 has a slot to prevent it from making a complete circle. The ends of the cover ring 1200 may be spaced apart form the center of the gap between the ends by between about 0.01 inches to about 0.03 inches as shown by arrows 1238. The ends of the cover ring 1200 may be spaced apart a total distance of between about 0.03 inches to about 0.05 inches as shown by arrows 1240. The middle flange may have a diameter of between about 14 inches to about 15 inches as shown by arrows 1204. The diameter of the opening in the cover ring 1200 may be between about 13 inches and about 14 inches as shown by arrows 1202.

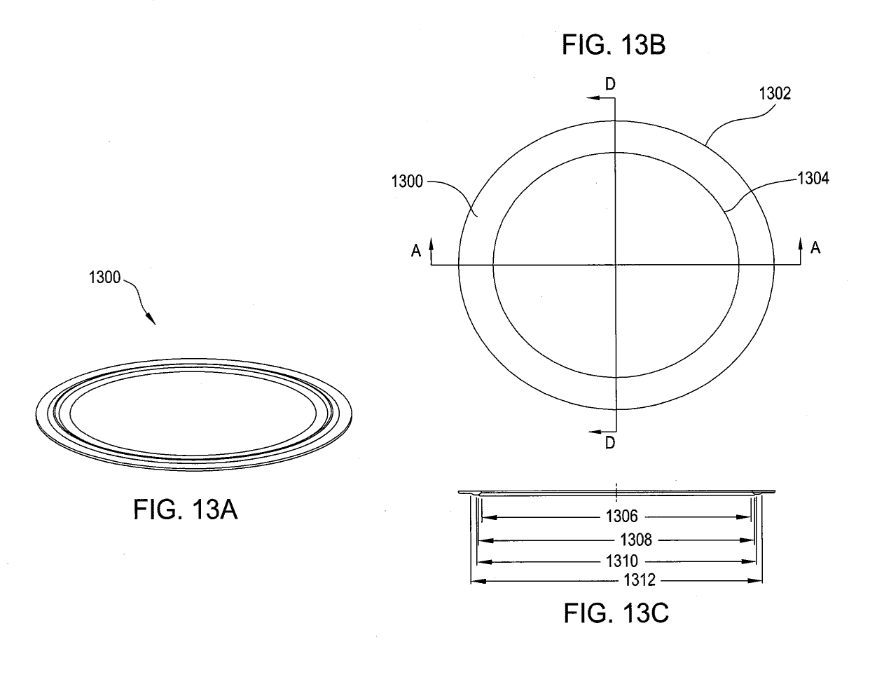

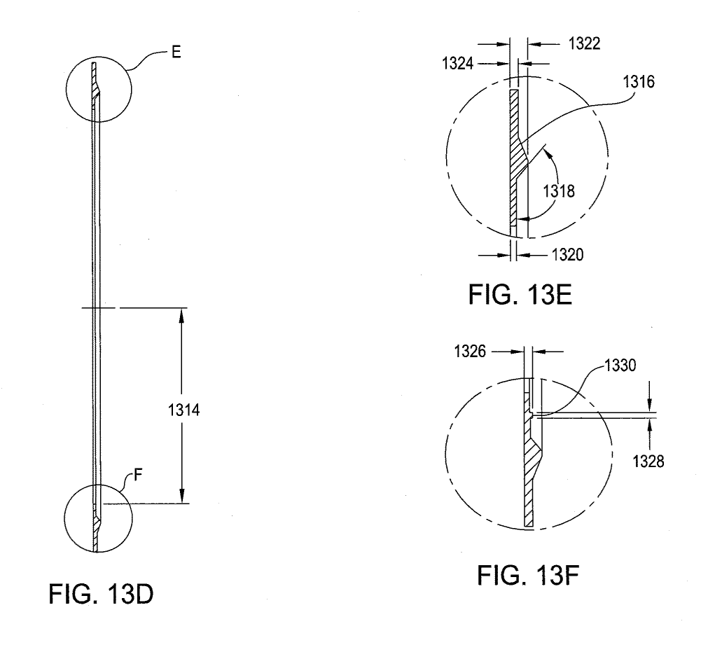

FIGS. 13A-13F are schematic representations of a cover ring 1300 according to another embodiment. FIG. 13B is a top view of the cover ring 1300. The cover ring 1300 has an outside diameter of between about 430 mm and about 460 mm as shown by arrows 1302. The cover ring 1300 has an inside diameter of between about 325 mm and about 360 mm as shown by arrows 1304. The cover ring 1300 has additional diameters that correspond to FIGS. 13D-13F are between about 375 mm and about 390 mm as shown by arrows 1306, between about 390 mm and about 400 mm as shown by arrows 1308, between about 295 mm and about 405 mm as shown by arrows 1310 and between about 400 mm and about 420 mm as shown by arrows 1312. The cover ring 1300 has an inner lip that has its center line 1330 disposed at a radius of between about 180 mm and about 190 mm as shown by arrows 1314. In one embodiment, the cover ring 1300 may comprise clear quartz.

The cover ring 1300 has an outer flange that has a height of between about 2.0 mm and about 3.5 mm as shown by arrows 1324. An outer lip 1316 extends a height of between about 5.0 mm and about 7.5 mm as shown by arrows 1322. The cover ring 1300 has a thickness of between about 1.0 mm and about 2.5 mm as shown by arrows 1320. The outer lip 1316 extends from the cover ring 1300 at an angel of between about 140 degrees and about 145 degrees as shown by arrows 1318. The cover ring 1300 has a thickness of between about 2.0 mm and about 3.5 mm inside of the inner lip as shown by arrows 1326. The inner lip has a width of between about 1.0 mm and about 3.5 mm as shown by arrows 1328.

In one embodiment, the exhaust ring 120 may be disposed around the periphery of the carrier plate 114 to help prevent deposition from occurring in the lower volume 110 and also help direct exhaust gases from the chamber 102 to exhaust ports 109. In one embodiment, the exhaust ring 120 comprises silicon carbide. The exhaust ring 120 may also comprise alternative materials that absorb electromagnetic energy, such as ceramics.

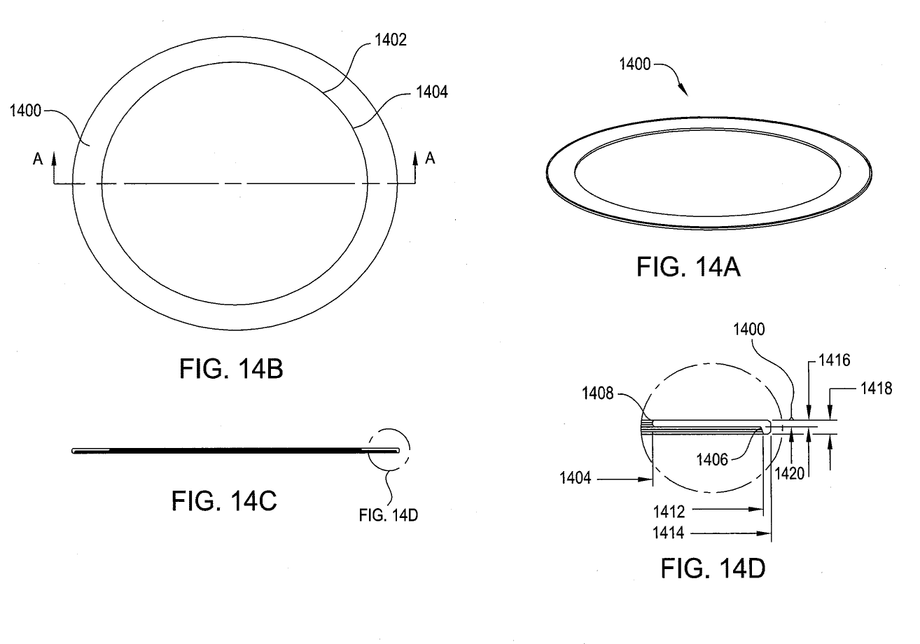

FIGS. 14A-14D are schematic representations of a top ring 1400 according to one embodiment. The top ring 1400 has an outer diameter of between about 500 mm and about 510 mm as shown by arrows 1402. The top ring 1400 has an inner diameter of between about 400 mm and about 425 mm as shown by arrows 1404. The top ring 1400 has a top portion 1420 having a thickness of between about 2.5 mm and about 3.5 mm as shown by arrows 1416. The top ring 1400 also has a flange that extends from the top portion. The flange has an inside edge 1412 and an outside edge 1414. The flange connects to the top portion at a corner 1406. The flange has a corner 1408 at the inside diameter. The top ring 1400 has a total thickness of between about 5.0 mm and about 7.5 mm as shown by arrows 1418.

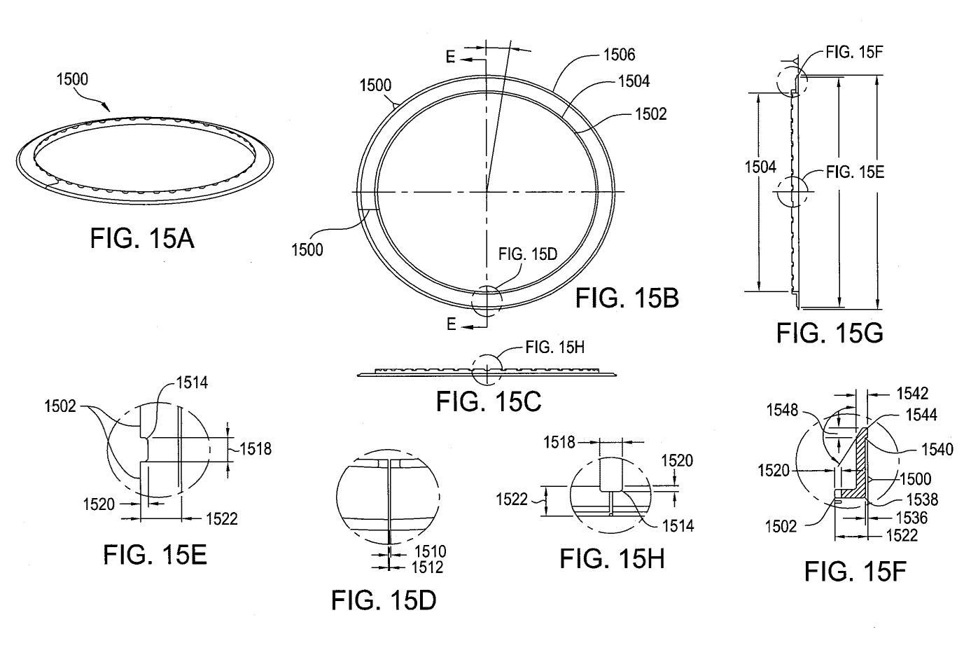

FIGS. 15A-15H are schematic views of an exhaust ring 1500 according to one embodiment. The exhaust ring 1500 may have a plurality of teeth 1502 that extend form the exhaust ring 1500. The teeth 1502 may be disposed at a diameter of between about 14 inches and about 15 inches as shown by arrows 1504. The outer diameter of the exhaust ring 1500 may be between about 16 inches and about 17 inches as shown by arrows 1506. The exhaust ring 1500 may not be a completely joined circle such that a gap may be present between the two ends of the exhaust ring 1500. The gap may have a width of between about 0.03 inches and about 0.05 inches as shown by arrows 1510 and a half width of between about 0.01 inches to about 0.03 inches as shown by arrows 1512.

The teeth 1502 may be spaced apart by a distance of between about 0.3 inches and about 0.4 inches as shown by arrows 1518. The teeth 1502 rise above the a gully 1514 in the exhaust ring 1500 by a distance of between about 0.05 inches to about 0.15 inches as shown by arrows 1520. The total height of the exhaust ring 1500 may be between about 0.5 inches to about 0.6 inches as shown by arrows 1522.

The exhaust ring 1500 has several corners 1538, 1540, 1544. The corners 1538, 1540 mark the location of a raised portion of the exhaust ring 1500. The raised portion is raised between about 0.03 inches and about 0.05 inches as shown by arrows 1536. The flange portion of the exhaust ring 1500 has a height of between about 0.15 inches and about 0.2 inches as shown by arrows 1542. The flange has a slanted surface having a run of between about 0.18 inches and about 0.21 inches as shown by arrows 1548.

In one embodiment, the exhaust ring 120 is coupled with an exhaust cylinder 160. In one embodiment, the exhaust cylinder 160 is perpendicular to the exhaust ring 120. The exhaust cylinder 160 helps maintain uniform and equal radial flow from the center outward across the surface of the carrier plate 114 and controls the flow of gas out of process volume 108 and into the annular exhaust channel 105. The exhaust cylinder 160 comprises an annular ring 161 having an inner sidewall 162 and an outer side wall 163 with throughholes or slots 165 extending through the sidewalls and positioned at equal intervals throughout the circumference of the ring 161. In one embodiment, the exhaust cylinder 160 and the exhaust ring 120 comprise a unitary piece. In one embodiment the exhaust ring 120 and the exhaust cylinder 160 comprise separate pieces that may be coupled together using attachment techniques known in the art. With reference to FIG. 2, process gas flows downward from the showerhead assembly 104 toward the carrier plate 114 and travels radially outward over the light shield 117, through the slots 165 in the exhaust cylinder 160 and into the annular exhaust channel 105 where it eventually exits the chamber 102 via exhaust port 109. The slots in the exhaust cylinder 160 choke the flow of the process gas helping to achieve uniform radial flow over the entire susceptor plate 115. In one embodiment, inert gas flows upward through a gap formed between the light shield 117 and the exhaust ring 120 to prevent process gas from entering the lower volume 110 of the chamber 102 and depositing on the lower dome 119. Deposition on the lower dome 119 may affect temperature uniformity and in some cases may heat the lower dome 119 causing it to crack.

A gas delivery system 125 may include multiple gas sources, or, depending on the process being run, some of the sources may be liquid sources rather than gases, in which case the gas delivery system may include a liquid injection system or other means (e.g., a bubbler) to vaporize the liquid. The vapor may then be mixed with a carrier gas prior to delivery to the chamber 102. Different gases, such as precursor gases, carrier gases, purge gases, cleaning/etching gases or others may be supplied from the gas delivery system 125 to separate supply lines 131, 135 to the showerhead assembly 104. The supply lines may include shut-off valves and mass flow controllers or other types of controllers to monitor and regulate or shut off the flow of gas in each line. In one embodiment, precursor gas concentration is estimated based on vapor pressure curves and temperature and pressure measured at the location of the gas source. In another embodiment, the gas delivery system 125 includes monitors located downstream of the gas sources which provide a direct measurement of precursor gas concentrations within the system.

A conduit 129 may receive cleaning/etching gases from a remote plasma source 126. The remote plasma source 126 may receive gases from the gas delivery system 125 via a supply line 124, and a valve 130 may be disposed between the shower head assembly 104 and remote plasma source 126. The valve 130 may be opened to allow a cleaning and/or etching gas or plasma to flow into the shower head assembly 104 via supply line 133 which may be adapted to function as a conduit for a plasma. In another embodiment, cleaning/etching gases may be delivered from the gas delivery system 125 for non-plasma cleaning and/or etching using alternate supply line configurations to shower head assembly 104. In yet another embodiment, the plasma bypasses the shower head assembly 104 and flows directly into the processing volume 108 of the chamber 102 via a conduit (not shown) which traverses the shower head assembly 104.

The remote plasma source 126 may be a radio frequency or microwave plasma source adapted for chamber 102 cleaning and/or substrate 140 etching. Cleaning and/or etching gas may be supplied to the remote plasma source 126 via supply line 124 to produce plasma species which may be sent via conduit 129 and supply line 133 for dispersion through showerhead assembly 104 into chamber 102. Gases for a cleaning application may include fluorine, chlorine or other reactive elements.

In another embodiment, the gas delivery system 125 and remote plasma source 126 may be suitably adapted so that precursor gases may be supplied to the remote plasma source 126 to produce plasma species which may be sent through showerhead assembly 104 to deposit CVD layers, such as III-V films, for example, on substrates 140.

A purge gas (e.g., nitrogen) may be delivered into the chamber 102 from the showerhead assembly 104 and/or from inlet ports or tubes (not shown) disposed below the carrier plate 114 and near the bottom of the chamber body 103. The purge gas enters the lower volume 110 of the chamber 102 and flows upwards past the carrier plate 114 and exhaust ring 120 and into multiple exhaust ports 109 which are disposed around an annular exhaust channel 105. An exhaust conduit 106 connects the annular exhaust channel 105 to a vacuum system 112 which includes a vacuum pump (not shown). The chamber 102 pressure may be controlled using a valve system 107 which controls the rate at which the exhaust gases are drawn from the annular exhaust channel 105.

The showerhead assembly 104 is located near the carrier plate 114 during substrate 140 processing. In one embodiment, the distance from the showerhead assembly 104 to the carrier plate 114 during processing may range from about 4 mm to about 40 mm.

During substrate processing, according to one embodiment of the invention, process gas flows from the showerhead assembly 104 towards the surface of the substrate 140. The process gas may comprise one or more precursor gases as well as carrier gases and dopant gases which may be mixed with the precursor gases. The draw of the annular exhaust channel 105 may affect gas flow so that the process gas flows substantially tangential to the substrates 140 and may be uniformly distributed radially across the deposition surfaces of the substrate 140 deposition surfaces in a laminar flow. The processing volume 108 may be maintained at a pressure of about 760 Torr down to about 80 Torr.

Reaction of process gas precursors at or near the surface of the substrate 140 may deposit various metal nitride layers upon the substrate 140, including GaN, aluminum nitride (AlN), and indium nitride (InN). Multiple metals may also be utilized for the deposition of other compound films such as AlGaN and/or InGaN. Additionally, dopants, such as silicon (Si) or magnesium (Mg), may be added to the films. The films may be doped by adding small amounts of dopant gases during the deposition process. For silicon doping, silane (SiH₄) or disilane (Si₂H₆) gases may be used, for example, and a dopant gas may include Bis(cyclopentadienyl) magnesium (Cp₂Mg or (C₅H₅)₂Mg) for magnesium doping.

In one embodiment, a fluorine or chlorine based plasma may be used for etching or cleaning. In other embodiments, halogen gases, such as Cl₂, Br, and I₂, or halides, such as HCl, HBr, and HI, may be used for non-plasma etching.

In one embodiment, a carrier gas, which may comprise nitrogen gas (N₂), hydrogen gas (H₂), argon (Ar) gas, another inert gas, or combinations thereof may be mixed with the first and second precursor gases prior to delivery to the showerhead assembly 104.

In one embodiment, the first precursor gas may comprise a Group III precursor, and second precursor gas may comprise a Group V precursor. The Group III precursor may be a metal organic (MO) precursor such as trimethyl gallium (“TMG”), triethyl gallium (TEG), trimethyl aluminum (“TMAl”), and/or trimethyl indium (“TMI”), but other suitable MO precursors may also be used. The Group V precursor may be a nitrogen precursor, such as ammonia (NH₃).

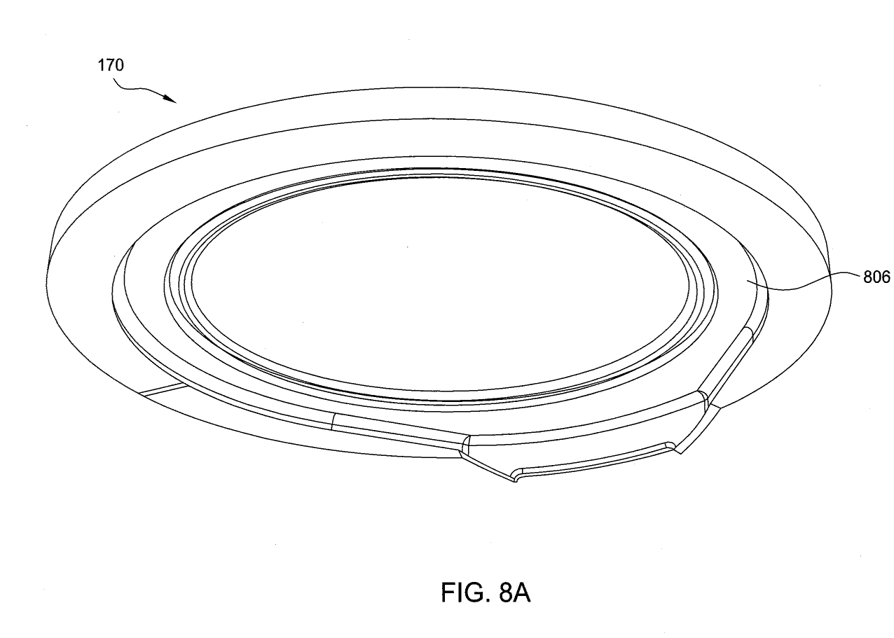

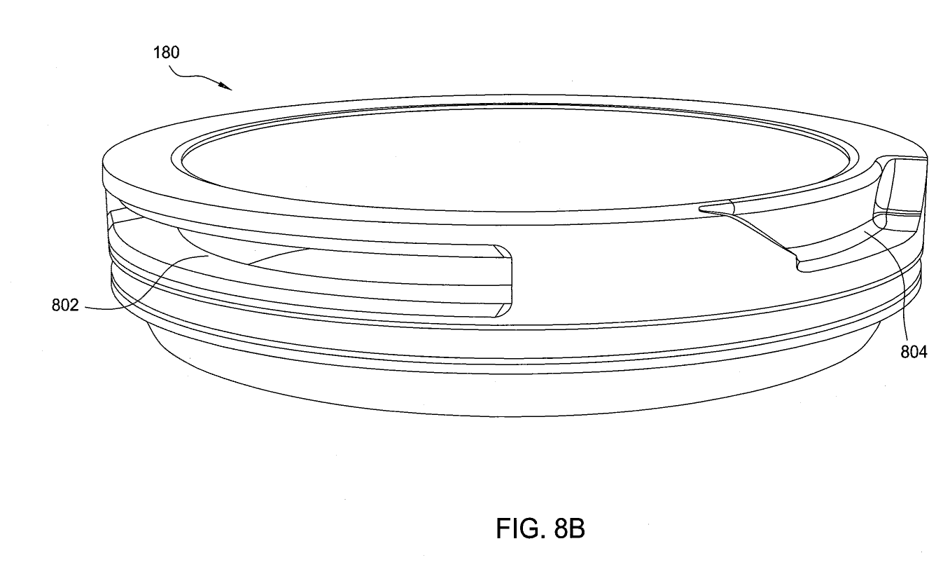

FIG. 8A is a perspective view of an upper liner according to one embodiment of the invention. FIG. 8B is a perspective view of a lower liner according to one embodiment of the invention. In one embodiment, the process chamber 102 further comprises an upper process liner 170 and a lower process liner 180 which help protect the chamber body 103 from etching by process gases. In one embodiment, the upper process liner 170 and the lower process liner 180 comprise a unitary body. In another embodiment, the upper process liner 170 and the lower process liner 180 comprise separate pieces. The lower process liner 180 is disposed in the lower volume 110 of the process chamber 102 and upper process liner 170 is disposed adjacent to the showerhead assembly 104. In one embodiment, the upper process liner 170 rests on the lower process liner 180. In one embodiment, lower liner 170 has a slit valve port 802 and an exhaust port 804 opening which may form a portion of exhaust port 109. The upper process liner 170 has an exhaust annulus 806 which may form a portion of annular exhaust channel 105. The liners may comprise thermally insulating material such as opaque quartz, sapphire, PBN material, ceramic, derivatives thereof or combinations thereof.

An improved deposition apparatus and process that provides uniform precursor flow and mixing while maintaining a uniform temperature over larger substrates and larger deposition areas has been provided. The uniform mixing and heating over larger substrates and/or multiple substrates and larger deposition areas is desirable in order to increase yield and throughput. Further uniform heating and mixing are important factors since they directly affect the cost to produce an electronic device and, thus, a device manufacturer's competitiveness in the market place.

While the foregoing is directed to embodiments of the present invention, other and further embodiments of the invention may be devised without departing from the basic scope thereof, and the scope thereof is determined by the claims that follow.

1. A substrate carrier, comprising:
a substrate carrier body having twenty-eight slots formed therein, wherein the slots are disposed such that the center of the slots are centered along three separate radial distances from the center of the substrate carrier body, wherein three slots are disposed along a first diameter, nine slots are disposed along a second diameter that is greater than the first diameter, and sixteen slots are disposed along a third diameter that is greater than the second diameter.

2. The substrate carrier of claim 1, wherein the slots have a concave surface relative to a substrate to be positioned therein.

3. The substrate carrier of claim 2, wherein the slots have a sidewall extending from the concave surface to a top surface of the substrate carrier body.

4. The substrate carrier of claim 1, wherein three slots are disposed along a diameter of between about 2.0 inches and about 3.0 inches.

5. The substrate carrier of claim 4, wherein nine slots are disposed along a diameter of between about 6.0 inches and about 7.0 inches.

6. The substrate carrier of claim 5, wherein sixteen slots are disposed along a diameter of between about 10 inches and about 11 inches.

7. The substrate carrier of claim 1, wherein an outside diameter of the carrier body is between about 13 inches and about 14 inches.

8. The substrate carrier of claim 1, wherein a center of a slot along the innermost diameter and the center of a slot along the outermost diameter are spaced apart by between about 8 degrees and about 11 degrees.

9. A substrate carrier, comprising:
a substrate carrier body having a plurality of slots formed therein, wherein each slot has a sidewall and a concave bottom surface extending from the sidewall.

10. The substrate carrier of claim 9, wherein the slots are arranged concentrically such that a plurality of first slots are disposed at a first diameter from the center of the carrier body, a plurality of second slots are disposed at a second diameter from the center of the carrier body, and a plurality of third slots are disposed along a third diameter from the center of the carrier body.

11. The substrate carrier of claim 10, wherein the plurality of first slots are disposed along a diameter of between about 2.0 inches and about 3.0 inches.

12. The substrate carrier of claim 11, wherein the plurality of second slots are disposed along a diameter of between about 6.0 inches and about 7.0 inches.

13. The substrate carrier of claim 12, wherein the plurality of third slots are disposed along a diameter of between about 10 inches and about 11 inches.

14. The substrate carrier of claim 13, wherein an outside diameter of the carrier body is between about 13 inches and about 14 inches.

15. The substrate carrier of claim 10, wherein a center of a slot along the innermost diameter and the center of a slot along the outermost diameter are spaced apart by between about 8 degrees and about 11 degrees.
